(19) United States
(12) Patent Application Publication
(10) Pub. No.: US 2022/0112732 A1
(43) Pub. Date: Apr. 14, 2022

(54) MICROWAVE ENHANCED 3D CONCRETE PRINTING

(71) Applicant: X Development LLC, Mountain View, CA (US)

(72) Inventors: Antonio Raymond Papania-Davis, Oakland, CA (US); Neil David Treat, San Jose, CA (US)

(21) Appl. No.: 17/069,163

(22) Filed: Oct. 13, 2020

(51) Int. Cl. E04G 21/06; B33Y 10/00; B05B 9/00; B05B 1/24; B28B 1/00; E04B 1/16; B05B 3/00; E04G 21/04; B33Y 50/02; B33Y 30/00

(52) U.S. Cl. CPC E04G 21/06; B33Y 10/00; B05B 9/002; B05B 1/24; B33Y 30/00; E04B 1/16; B05B 3/001; E04G 21/04; B33Y 50/02; B28B 1/001

(57) ABSTRACT

Methods, systems, and apparatus, for performing additive manufacturing with concrete. One example is an additive manufacturing print head. The print head includes a body defining an internal flow path, a print nozzle at an outlet of the internal flow path, an auger disposed within the internal flow path, a first microwave emitter, and a second microwave emitter. The auger is operable to convey a concrete mixture towards the print nozzle. The first microwave emitter is operable to alter a viscosity of the concrete moisture within the flow path by directing first microwave energy towards the internal flow path. The second microwave emitter is arranged to direct second microwave energy towards the concrete mixture when it exits the print nozzle.

### BACKGROUND

Concrete additive manufacturing has shown promise in the construction and infrastructure spaces. Traditional formwork for cast-in-place concrete structures, which can account for as much as 50% construction concrete costs, is not required to form concrete structures using additive manufacturing. However, while lab-scale experiments have conceptually demonstrated the potential of powder bed concrete printers on a small scale, building scale printers have solely relied on extruded fused deposition modeling (FDM) style 3D printing techniques. FDM 3D printers allow for the most versatility and scale, but also have a number of disadvantages, including the need for specialized formulations of high yield stress and adhesions characteristics to prevent layer distortion due to slow curing times and layer delamination.

Current specialty concrete formulations limit printing speeds and require material deposition with large layer thicknesses creating rough surface finishes. These concrete formulations also require long curing times, which ultimately limit geometries that can be achieved without additional supporting structure. These challenges limit the capabilities of concrete 3D printing as compared to polymer based 3D printers. Ultimately, slow curing rates are fundamentally a barrier to outperforming more conventional concrete casting techniques and thus to mass adoption.

### SUMMARY

In general, the disclosure generally relates to a system for performing additive manufacturing with concrete. In particular, microwave emitters are used to tune concrete viscosity and to improve concrete curing during an additive manufacturing process. Microwave radiation, unlike conventional heating, penetrates through the concrete mixture, thereby, more evenly heating the entire mixture from the surface to the center of the mixture. This more even heating ability can provide more control over the viscosity of the concrete mixture in the print head, improve the initial strength of each printed concrete layer, and reduce overall cure time. These improvements in control and strength of the concrete mixture may allow for the creation of more complex cantilevered concrete geometries through additive manufacture than can be typically achieved by traditional casting approaches and recede or eliminate the need for the complex and expensive form work.

One aspect includes a concrete print head with independently controlled microwave emitters. One emitter (or set of emitters) is located at the outlet of a print nozzle and aids in curing the concrete mix as it exits the nozzle. This curing emitter is operable to enhance the initial curing of the concrete as it exits the nozzle. The curing emitter directs microwave energy towards the concrete as it exits the nozzle to speed the initial curing process. The curing emitter is used to harden each printed layer of concrete sufficiently to support a subsequent printed layer on top with minimal deformation of the preceding layer.

A second emitter (or set of emitters) is located along the print head body to control the viscosity of the concrete mixture as it is conveyed through the print head towards the nozzle. This viscosity control emitter is arranged to direct microwave energy into a flow path of the concrete through the print head and is operable to adjust the viscosity of the concrete as it flows through the print head.

Each of the microwave emitters (or sets of emitters) can be controlled independently. For example, the curing emitter can be controlled to heat concrete exiting the nozzle to a temperature just below boiling. Or if a foam-like consistency is desired, the curing emitter can be controlled to allow the concrete mix to boil slightly. The viscosity control emitter is controlled to maintain a desired viscosity of the concrete mixture flowing through the print head, e.g., to aid in maintaining g a desired flow rate of the moisture through the print head. In some implementations, the viscosity of the concrete mix is controlled by applying a consistent dose of microwave energy to the mixture as it passes through the print head. For example, a lookup table that relates emitter power to mix flow rate and desired viscosity can be used to control the output power of the viscosity control emitter. Some implementations can include a viscosity feedback sensor to measure or estimate the actual viscosity of the concrete mix and adjust the output power of the viscosity control emitter accordingly. For example, the backpressure of concrete mix can be measured and used to estimate the viscosity of the mixture.

In some implementations, additives that interact with microwave energy can be added to the concrete mixture to improve the heating capability of the microwave emitters. For example, additives can be added to concrete mixtures for added strength while allowing for a further reduction curing time as they will radiate heat from the microwaves into the mixture internally. Such additives include, but are not limited to, conductive iron, steel, or carbon fiber.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A depicts a front-view of an exemplary additive manufacturing print head.

FIG. 1B depicts a side-view of the exemplary additive manufacturing print head.

FIG. 2 depicts a block diagram of an exemplary control system for the additive manufacturing print head of FIGS. 1A and 1B.

FIG. 3 depicts a flow diagram that illustrates an example process for operating the additive manufacturing print head of FIGS. 1A and 1B.

FIG. 4 depicts a schematic diagram of a computer system that may be applied to any of the computer-implemented methods and other techniques described herein.

Like reference numbers and designations in the various drawings indicate like elements.

### DETAILED DESCRIPTION

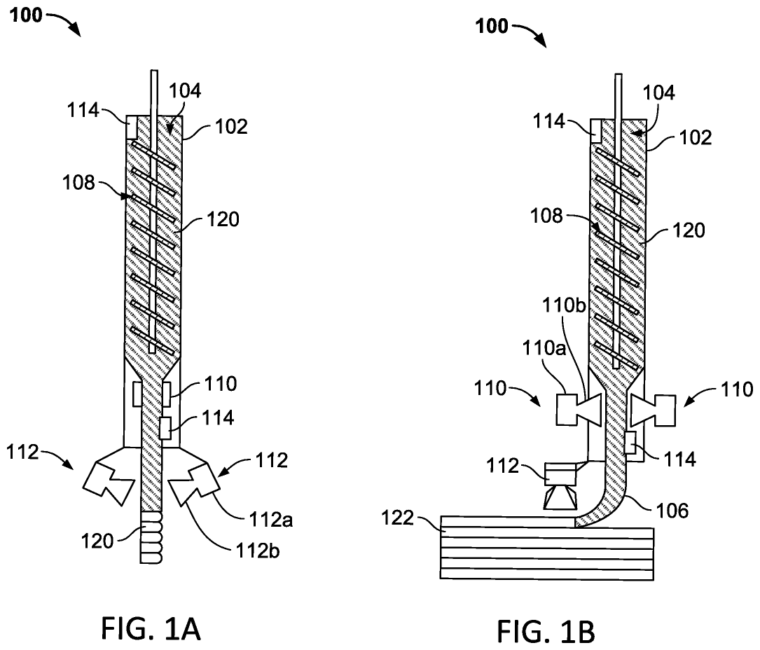

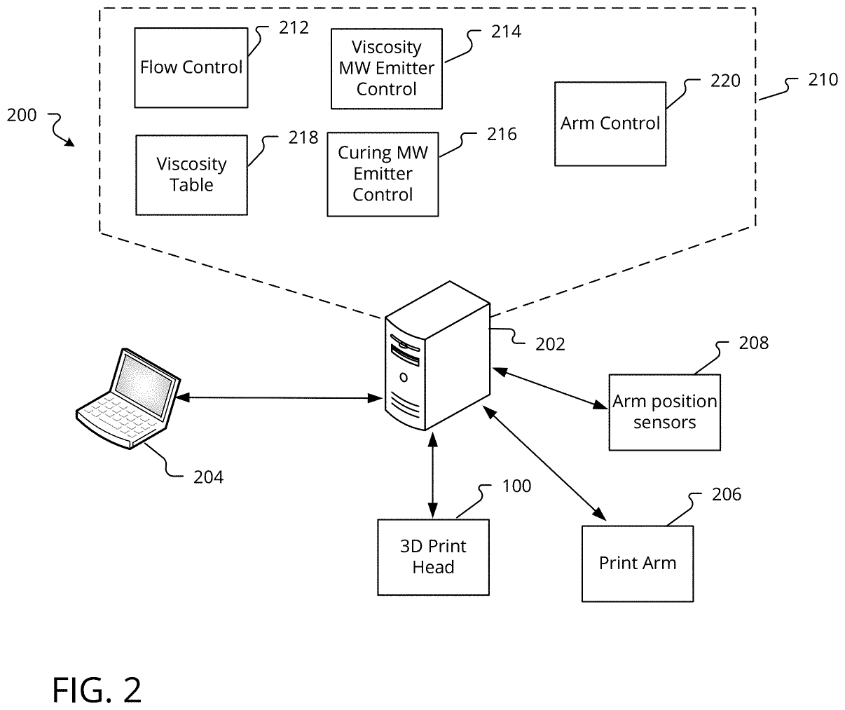

FIGS. 1A and 1B depict views of an exemplary additive manufacturing (e.g., 3D printing) print head 100. Print head 100 can be used with a concrete 3D printing system. In operation, print head 100 can be coupled to a mechanical arm of a 3D printing system. For example, print head 100 can be coupled to a robotic concrete supply boom of a concrete 3D printing system. The 3D printing system maneuvers the print head 100 around a series of coordinates while the print head dispenses a concrete mixture to create a concrete structure. Operation print head 100 in coordination with a 3D printing system is described in more detail below in reference to FIG. 2.

FIG. 1A depicts a front-view of an exemplary additive manufacturing print head 100 and FIG. 1B depicts a side-view of the additive manufacturing print head 100. Print head 100 includes a body 102 defining an internal flow path 104 for a concrete mixture 120. A nozzle 106 is located at the outlet of the internal flow path 104. The print head 100 includes an auger disposed within the internal flow path 104 to convey the concrete mixture 120 through the flow path 104 towards the nozzle 106. The print head 100 deposes the concrete mixture in layers 122 to form a 3D printed concrete structure.

The print head 100 includes independently controlled microwave emitters 110, 112. Microwave emitters 110, 112 transmit microwave energy into the concrete mixture 120. The microwave energy penetrates into the concrete mixture 120 promoting more even heating throughout the mixture when compared to other traditional heating mechanisms such as infrared or gas heating. If needed or desired, additives can be included in the concrete mixture 120 to further promote more even heating. For example, additives that are receptive to microwave energy can be added to the concrete mixture 120. Such additives include, but are not limited to, any one or combination of conductive iron, steel, carbon fiber, or other additives that will radiate heat into the mixture internally with the application of microwaves. Such additives may be added to concrete mixtures for added strength while also allowing for a further reduction curing time due to their interaction with the microwaves.

Print head 100 can include a first microwave emitter 110, or set of emitters, positioned on the body. Emitter 110 can be configured as a viscosity control emitter. For example, emitter 110 is positioned adjacent to the internal flow path of the print head 100. Emitter 110 is arranged to direct microwave energy towards the concrete mixture 120 flowing through the internal flow path 104. The emitter 110 can include a magnetron 110a coupled to a waveguide 110b. The magnetron 110a generates microwave energy and the waveguide 110b directs the microwave energy towards the concrete mixture 120. For example, the waveguide 110b can be arranged on the print head 100 to direct microwave energy into a portion of the internal flow path 104. In some implementations, the waveguide 110b can be configured as a horn antenna.

Emitter 110 is used to adjust the viscosity of the concrete mixture 120 within the internal flow path 104. The microwave energy emitted by the viscosity control emitter 110 heats the concrete mixture 120 as it passes through the internal flow path 104, thereby altering its viscosity. For example, the viscosity of the concrete mixture 120 can be controlled by applying a consistent dose of microwave energy to the mixture as it passes through the print head 100. For example, a lookup table that relates emitter power to mixture flow rate and desired viscosity can be used to control the output characteristics of microwave energy output by the viscosity control emitter 110. Some implementations can include a viscosity feedback sensor to measure or estimate the actual viscosity of the concrete mixture 120 within the print head 100. The emitter 110 can be configured to adjust the output characteristics of the microwave energy accordingly. Microwave output characteristics controlled by the emitter 110 can include microwave power and frequency.

In some implementations, viscosity control emitter 110 can be employed to adjust the viscosity of the concrete mixture 120 to provide a desired concrete viscosity at the outlet of the nozzle 106. For example, different concrete viscosities may be desirable for different portions of a concrete structure. For instance, a higher viscosity may be used to print cantilevered portions of a concrete structure, while a lower viscosity is used to print other portions of a concrete structure (e.g., a vertical wall). In such implementations, the emitter 110 can adjust the output characteristics of the microwave energy in accordance with the position of the print head 100 in relation to a concrete structure being printed to achieve a desired viscosity for the concrete dispensed at the position. In other words, the viscosity emitter 110 can adjust its output as the print head 100 is moved to print various aspects of a concrete structure.

Although two viscosity control emitters 110 are illustrated in FIGS. 1A and 1B, the print head 100 can include any number of viscosity control emitters 110. For example, an array of viscosity control emitters 110 can be arranged along the length of the internal flow path to progressively heat the concrete mixture 120 in the flow path, thus, gradually changing the viscosity of the concrete mixture 120 as it is conveyed along the length of the print head 100.

Print head 100 can also include a second microwave emitter 112, or set of emitters, positioned proximate to the outlet of the nozzle 106. Emitter 112 can be configured as a curing emitter. For example, emitter 112 is positioned at the outlet of the nozzle 106 and is arranged to direct microwave energy towards the concrete mixture 120 flowing out of the nozzle 106. The emitter 112 can include a magnetron 112a coupled to a waveguide 112b. The magnetron 112a generates microwave energy and the waveguide 112b directs the microwave energy towards the concrete mixture 120. For example, the waveguide 112b can be arranged on the print head 100 to direct microwave energy towards the outlet of the nozzle 106. In some implementations, the waveguide 112b can be configured as a horn antenna. In some implementations, the curing emitter 112 can be mounted on a separate curing head that is maneuvered around a 3D printed concrete structure independently from the print head 100.

Emitter 112 is used to improve curing of the concrete mixture 120 as it exits the nozzle 106. The microwave energy emitted by the curing emitter 112 heats the concrete mixture 120 as it is deposited in layers 122 on a printed concrete structure, thereby helping to cure the concrete more rapidly as it is deposited. For example, the curing emitter 112 can be controlled to heat concrete exiting the nozzle 106 to a temperature just below boiling to facilitate more rapid curing. In some implementations, if a foam-like concrete consistency is desired, the curing emitter 112 can be controlled to allow the concrete mix to boil slightly.

In some implementations, the output characteristics of microwave energy output by the curing emitter 112 can be adjusted based on the position of the print head 100 relative to the concrete structure or the speed at which the print head 100 is moving. For example, some portions of the concrete structure may require faster cure times than other portions of the structure. Thus, the curing emitter 112 can control the output characteristics of the microwave energy based on which portion of a concrete structure the print head 100 is printing at a given time. In addition or alternatively, the curing emitter can adjust output characteristics of microwaves if the speed at which the print head 100 is moved along a structure changes. For example, the output power of the curing emitter 112 can be increased as the print head 100 is moved faster to ensure a proper dose of microwave energy is applied to the concrete mix to achieve a desired internal temperature and a desired amount of curing. Microwave output characteristics controlled by the emitter 112 can include microwave power and frequency.

Although two curing emitters 112 are illustrated in FIGS. 1A and 1B, the print head 100 can include any number of curing emitters 112. For example, an array of curing emitters 110 can be arranged along an extension arm extending from the bottom of the print head 100 to progressively heat and cure the deposited concrete mixture 120.

In some implementations, the print head 100 includes viscosity sensors 114. For example, viscosity sensors 114 can be coupled to the print head to measure characteristics of the concrete mixture 120 used to determine a viscosity of the mixture and provide feedback for controlling the viscosity control emitter 110, the curing emitter 112, or both. In some examples, viscosity sensors 114 may not measure viscosity directly, but can be configured to measure other characteristics of the concrete mixture 120 which can be used to estimate viscosity. Such characteristics can include, but are not limited to, backpressure, temperature, moisture content, flow measurements (e.g. ultrasonic flow measurements), measurements of the concrete composition (e.g., concrete formulation—particle size and distribution, water/cement ratio, etc.), or a combination thereof.

In some implementations, the print head 100, internal flow path 104, or other components can be made of electrically non-conductive materials to reduce or prevent interference with the microwaves.

FIG. 2 is a diagram of an exemplary concrete additive manufacturing system 200. The system 200 includes a control system 202, print head 100, a print arm 206, and arm position sensors 208. The print head 100 is coupled to the print arm 206 which maneuvers the print head 100 according to a layout of a structure to be printed. Arm position sensors 208 provide location feedback indicating the location of the print head 100 according to the layout at a given point in time. Control system 202 can include a system of one or more computing devices.

Control system 202 is configured to control various aspects of the concrete additive manufacturing process. For example, control system 202 can store and execute one or more computer instruction sets to control the execution of aspects of the concrete additive manufacturing processes described herein. For example, control system 202 is in communication with the print head 100 (including microwave emitters 110, 112, viscosity sensors 114, and auger 108), print arm 206, and arm position sensors 208. Control system 202 can control the operations of print head 100, viscosity control emitter(s) 110, curing emitter(s) 112, auger 108, and print arm 206 to execute a concrete additive manufacturing process.

In some implementations, the control system 202 can be operated or controlled from a user computing device 204. User computing device 204 can be a computing device, e.g., desktop computer, laptop computer, tablet computer, or other portable or stationary computing device.

Briefly, control system 202 can control the overall operation of the print head 100 and print arm 206 to build a concrete structure by executing an additive manufacturing process. The control system 202 can receive an AM design file as input and control movement of the print arm 206 to maneuver the print head in accordance with the AM design file for building the structure. The arm positions sensors 208 provide feedback to the control system 202 about the location of the arm relative to the structure being build. As the print arm 206 is driven to print portions of the structure, the control system 202 controls the print head 100 to dispense concrete mixture 120 to form layers of the structure. The control system 202 can control operations of the print head 100 that include one or more of the dispense rate of concrete mixture 120 from the print head 100, the viscosity of the concrete mixture 120 dispensed, and the cure rate of the concrete layers by controlling operations of auger 108, viscosity control emitter(s) 110, and curing emitter(s) 112.

In some implementations, control system 202 can include a set of operations modules 210 for controlling different aspects of a concrete additive manufacturing process. The operation modules 210 can be provided as one or more computer executable software modules, hardware modules, or a combination thereof. For example, one or more of the operation modules 210 can be implemented as blocks of software code with instructions that cause one or more processors of the control system 202 to execute operations described herein. In addition or alternatively, one or more of the operations modules can be implemented in electronic circuitry such as, e.g., programmable logic circuits, field programmable logic arrays (FPGA), or application specific integrated circuits (ASIC). The operation modules 210 can include a flow controller 212, a viscosity microwave (MW) emitter controller 214, a curing MW emitter controller 216, and an arm controller 220. The operation modules can also include a viscosity table 218, which can be implemented a data structure relating viscosity measurements data (e.g., from viscosity sensors 114) to viscosity values and/or to operational settings for the viscosity control emitter(s) 110.

Arm controller 220 controls the movement of the print arm 206 in accordance with an AM structure design file. For example, arm controller 220 moves the print head 100 according to a layout geometry for a structure defined by the AM design file to build the structure in layers of printed concrete dispensed by the print head 100. The arm controller 220 can provide position information (e.g., from arm position sensor 208) to other operational modules 210 for control of various aspects of the print head 100 described below.

Flow controller 212 controls the flow rate of concrete mixture 120 from the print head 100. For example, flow controller 212 can control the operation of the auger 108 to dispense concrete from the print head 100 at a flow rate required by a particular AM design file being executed by the control system 202. In some implementations, the flow controller 212 can adjust a flow rate of the concrete mixture 120 based on the position and/or the speed of the print arm 206. For example, a particular portion of a structure may require thicker layers of concrete. When the control system 202 detects that the print arm 206 is positioned to print that particular portion of the structure, e.g., in accordance with arm position data from arm position sensors 208, then the flow controller 212 can increase the flow rate of the concrete mixture 120. For instance, the flow controller 212 can increase the drive speed of the auger 108. In addition, the arm position data may indicate the speed at which the print arm 206 is moving. The flow controller 212 can vary the flow rate of the concrete mixture 120 based on the speed of the print arm 206.

Viscosity MW emitter controller 214 controls the operation of the viscosity control emitter(s) 110. For example, the viscosity MW emitter controller 214 can control the magnetron 110a to set or adjust characteristics of the microwave energy output by the viscosity control emitter(s) 110. Characteristics of the microwave energy that can be controlled include, but are not limited to, power, frequency, pulse periods, or a combination thereof. For example, microwave power can be adjusted within ranges including, but not limited to, 1 kW to 20 kW or 0.1 kW to 2000 kW, for each magnetron. For example, microwave frequency can be adjusted within ranges including, but not limited to, 300 MHz to 300 GHz, 433.92 MHz to 40.00 GHz, for focused on a specific heating value of, e.g., 2.45 GHz.

As discussed above, the viscosity control emitter(s) 110 can be controlled to maintain or adjust the viscosity of the concrete mixture 100 as it flows through the print head 100. In some implementations, the viscosity MW emitter controller 214 can set the output of the viscosity control emitter(s) 110 to maintain application of a constant dose of microwave energy to the concrete mixture 120. For example, some construction situations may simply require a constant pre-defined concrete viscosity for an entire project.

In such situations, the control system 202 may permit a user to enter either a desired viscosity for the project or a desired microwave dose (e.g., watts per volume of concrete). If the desired microwave dose is entered, the viscosity MW emitter controller 214 can set the output of the viscosity control emitter(s) 110 to maintain the desired dose while adjusting the output power for any changes in flow rate of the concrete mixture 120 through the print head 100 as needed.

If a desired viscosity is entered, the viscosity MW emitter controller 214 can employ a data structure, such as viscosity table 218, to determine applicable settings for the viscosity control emitter(s) 110 to achieve the desired viscosity. In such situations, however, the control system 202 may require additional data about the concrete mixture being used to determine appropriate settings for the viscosity control emitter(s) 110. The additional data can include, but is not limited to, type of concrete, ingredients of the concrete, moisture content (e.g., water to concrete ratio), and the type and amount of any additives.

The viscosity table 218 can be a lookup table including experimentally verified values of concrete viscosity under various conditions. For example, the viscosity table 218 can relate viscosity values of different types of concrete to different microwave dose rates. In some examples, the microwave dose rates can identify particular frequencies. For instance, some additives may be absorb and radiate more energy from the microwaves at different wavelengths.

In some implementations, the control system 202 receives viscosity measurements from viscosity sensors 114. The control system 202 can use the viscosity measurements as feedback for controlling the output of the viscosity control emitter(s) 110. For example, the viscosity MW emitter controller 214 can adjust the output of the viscosity control emitter(s) 110 based on the viscosity measurements. For instance, if the viscosity measurements indicate that the concrete mixture is more viscous than required for a given structure or portion of a structure, then the viscosity MW emitter controller 214 can reduce the output power of the microwave energy. Otherwise, if the viscosity measurements indicate that the concrete mixture is less viscous than required for a given structure or portion of a structure, then the viscosity MW emitter controller 214 can increase the output power of the microwave energy.

In some implementations, the viscosity sensors 114 do not measure viscosity directly but instead measure characteristics of the concrete mixture that can be used to determine or estimate viscosity. Such characteristics can include, but are not limited to, backpressure, temperature, moisture content moisture content, flow measurements (e.g. ultrasonic flow measurements), measurements of the concrete composition (e.g., concrete formulation—particle size and distribution, water/cement ratio, etc.), or a combination thereof. The viscosity MW emitter controller 214 can then estimate the viscosity of the concrete mixture 120 from the measured concrete characteristics. For example, viscosity can be estimated by measuring the pressure difference between two points along the internal flow path 104 (e.g., the entrance and exit of the tube with constant cross-section) and measuring the volumetric flow rate of the concrete mixture 120. The viscosity is proportional to the pressure difference. For instance, some stress (such as a pressure difference) is needed to sustain the flow through internal flow path 104. The strength of this stress (e.g., pressure difference) force is proportional to viscosity.

In some implementations, the viscosity table 218 includes data relating various concrete measurements to viscosity values. For example, the viscosity table 218 can include relationships between moisture content for various different concrete mixes and the expected viscosity (e.g., based on experimentally determined viscosities) at each value moisture content. The viscosity MW emitter controller 214 can then estimate the viscosity of the concrete mixture 120 from the viscosity table 218 by, e.g., identifying the estimated viscosity in the table based on a measured parameter of the concrete mixture 120 in the print head 100.

In some implementations, the viscosity MW emitter controller 214 can adjust the output of the viscosity control emitter(s) 110 to tune the viscosity of the concrete mixture 120 as based on the particular portion of a structure being printed. For instance, if an AM (Additive Manufacturing) design file specifies different concrete viscosities for different portions of a structure, the viscosity MW emitter controller 214 can adjust the characteristics of the microwave energy output by the viscosity control emitter(s) 101 to meet or approximate the specified viscosity. For instance, a more viscous concrete mixture may be used to print a cantilevered portion of a structure, while a less viscous concrete moisture may be used to print a vertical wall. The higher viscosity concrete may aid in forming the cantilevered portion without it collapsing, while the lower viscosity may allow the vertical wall to be printed at a faster rate.

Curing MW emitter controller 216 controls the operation of the curing control emitter(s) 112. For example, the curing MW emitter controller 216 can control the magnetron 112a to set or adjust characteristics of the microwave energy output by the viscosity control emitter(s) 110. Characteristics of the microwave energy that can be controlled include, but are not limited to, power, frequency, pulse periods, or a combination thereof. For example, microwave power can be adjusted within ranges including, but not limited to, 1 kW to 20 kW or 0.1 kW to 2000 kW, for each magnetron. For example, microwave frequency can be adjusted within ranges including, but not limited to, 300 MHz to 300 GHz, 433.92 MHz to 40.00 GHz, for focused on a specific heating value of, e.g., 2.45 GHz.

As discussed above, the curing emitter(s) 112 can be controlled to pre-cure the concrete mixture as it flows out of the nozzle 106. For example, the curing MW emitter controller 216 can control the microwave output by the curing emitter 112 to heat concrete exiting the nozzle 106 to a temperature just below boiling to facilitate more rapid curing. In some implementations, if a foam-like concrete consistency is desired, the curing emitter 112 can be controlled to allow the concrete mix to boil slightly.

In some implementations, the curing MW emitter controller 216 can control the characteristics of microwave energy output by the curing emitter(s) 112 based on the position of the print head 100 relative to the concrete structure or the speed at which the print head 100 is moving. For example, some portions of the concrete structure may require faster cure times than other portions of the structure. Thus, the curing MW emitter controller 216 can control can control the output characteristics of the microwave energy (e.g., power and/or frequency) based on to position of the print head 100 relative to the structure, i.e., which portion of a concrete structure the print head 100 is printing at a given time.

In addition or alternatively, the curing MW emitter controller 216 can adjust the curing emitter(s) 112 if the speed at which the print head 100 is moved along a structure changes. For example, the output power of the curing emitter 112 can be increased as the print head 100 is moved faster to ensure a proper dose of microwave energy is applied to the concrete mix to achieve a desired internal temperature and a desired amount of curing.

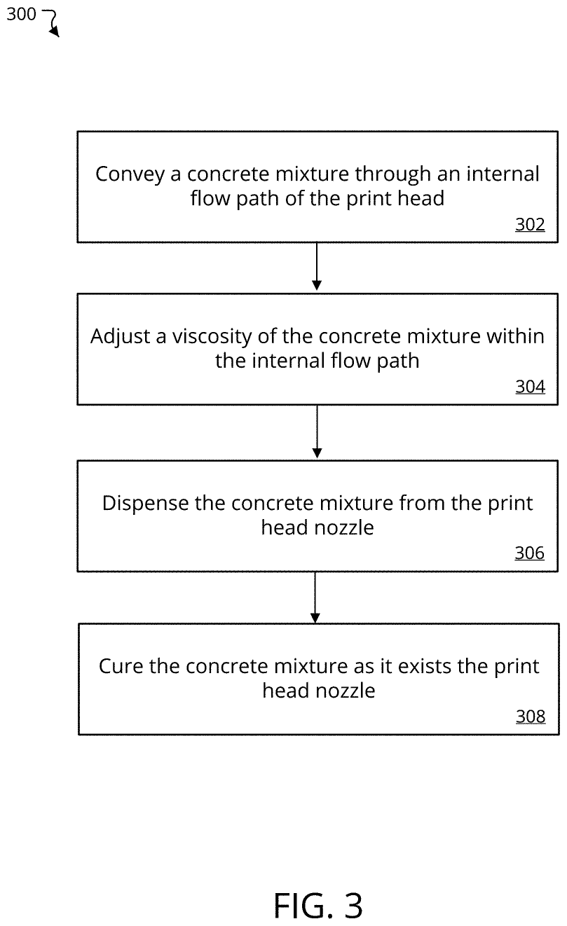

FIG. 3 is a flow diagram that illustrates a process 300 for controlling operation of a concrete additive manufacturing print head 100. The process 300 can be performed by one or more computing devices. For example, as discussed above, the process 300 may be performed by control system 202 of FIG. 2. For convenience, operations of process 300 is described as being performed by a control system. However, as noted above, some or all of the operations may be performed by various operation modules of an additive manufacturing control system.

The control system conveys a concrete mixture through an internal flow path of an additive manufacturing print head (302). For example, the control system can control operation of an auger within the print head to convey the concrete mixture through the print head and out of a nozzle at the end of the print head.

The control system controls a viscosity of the concrete mixture within the internal flow path of the additive manufacturing print head (304). For example, the control system can control a first set of one or more microwave emitters to irradiate the concrete mixture with first microwave energy while the concrete mixture is conveyed through the flow path towards a print nozzle. As discussed above, the control system can control the viscosity control emitter(s) to provide a constant amount of microwave energy to the concrete mixture, or it can adjust output characteristics of the emitter(s) based on the speed that the print head moves, feedback from viscosity sensors, a location of the print head with respect to the structure being printed, or a combination thereof.

The control system dispenses the concrete mixture through the print nozzle of the print head (306). For example, by controlling the auger the control system can control a rate of concrete flow out of the nozzle.

The control system partially cures, or pre-cures, the concrete mixture as it exits the nozzle (308). For example, the control system can control a second set of one or more microwave emitters to irradiate the concrete mixture with second microwave energy as the concrete mixture exits the print nozzle. As discussed above, the control system can control the curing emitter(s) to heat the mixture as it exits the nozzle and pre-cure the concrete. The control system can control the output characteristics of the emitter(s) based on the speed that the print head moves, a location of the print head with respect to the structure being printed, or a combination thereof.

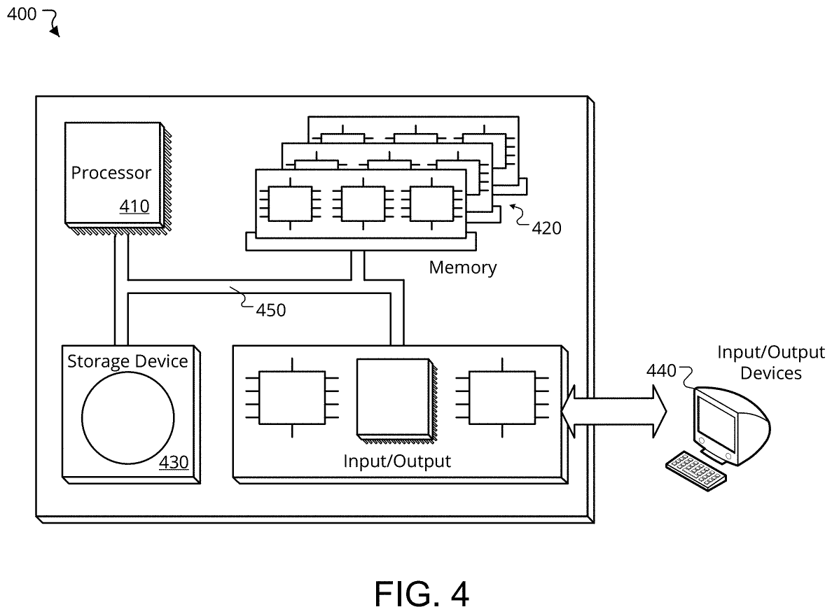

FIG. 4 is a schematic diagram of a computer system 400. The system 400 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 400) and their structural equivalents, or in combinations of one or more of them. The system 400 is intended to include various forms of digital computers, such as laptops, desktops, workstations, personal digital assistants, servers, blade servers, mainframes, and other appropriate computers, including vehicles installed on base units or pod units of modular vehicles. The system 400 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In addition to the embodiments described above, innovative aspects of the subject matter described in this specification are incorporated in the following embodiments.

Embodiment 1 is an additive manufacturing print head comprising: a body defining an internal flow path; a print nozzle at an outlet of the internal flow path; an auger disposed within the internal flow path, the auger operable to convey a concrete mixture towards the print nozzle; a first microwave emitter operable to alter a viscosity of the concrete moisture within the flow path by directing first microwave energy towards the internal flow path; and a second microwave emitter arranged to direct second microwave energy towards the concrete mixture when it exits the print nozzle.

Embodiment 2 is the additive manufacturing print head of embodiment 1, wherein the first microwave emitter comprises a magnetron operatively coupled to a waveguide horn.

Embodiment 3 is the additive manufacturing print head of embodiment 2, wherein an output of the waveguide horn is directed towards the internal flow path.

Embodiment 4 is the additive manufacturing print head of any one of embodiments 1-3, wherein the second microwave emitter comprises a magnetron operatively coupled to a waveguide horn.

Embodiment 5 is the additive manufacturing print head of embodiment 4, wherein the output of the waveguide horn is directed towards an outlet of the print nozzle.

Embodiment 6 is the additive manufacturing print head of any one of embodiments 1-5, wherein the first microwave emitter is one of a first set of microwave emitters, each microwave emitter in the first set of microwave emitters arranged to direct microwave energy towards a region of the internal flow path.

Embodiment 7 is the additive manufacturing print head of any one of embodiments 1-6, wherein the second microwave emitter is one of a second set of microwave emitters, each microwave emitter in the second set of microwave emitters arranged to direct microwave energy towards the concrete mixture when it exits the print nozzle.

Embodiment 8 is the additive manufacturing print head of any one of embodiments 1-7, wherein the concrete mixture comprises additives that are receptive to microwave energy.

Embodiment 9 is the additive manufacturing print head of any one of embodiments 1-8, further comprising a control system operatively coupled to the first microwave emitter and the second microwave emitter, the control system configured to control operation of the first microwave emitter to adjust a viscosity of concrete mixture within the internal flow path.

Embodiment 10 is the additive manufacturing print head of embodiment 9, wherein controlling operation of the first microwave emitter comprises controlling the first microwave emitter to adjust one or more characteristics of the first microwave energy.

Embodiment 11 is the additive manufacturing print head of embodiment 10, wherein the one or more characteristics comprise power or frequency of the first microwave energy.

Embodiment 12 is the additive manufacturing print head of embodiment 9, wherein controlling operations of the first microwave emitter comprises: receiving sensor measurements of characteristics of the concrete mixture in the internal flow path; and controlling the first microwave emitter to adjust one or more characteristics of the first microwave energy based on the characteristics of the concrete mixture in the internal flow path.

Embodiment 13 is the additive manufacturing print head of embodiment 9, wherein the control system is configured to control operation of the second microwave emitter to partially cure the concrete mixture as it exits the print nozzle.

Embodiment 14 is the additive manufacturing print head of embodiment 13, wherein the controlling operation of the second microwave emitter comprises controlling the second microwave emitter to adjust one or more characteristics of the second microwave energy.

Embodiment 15 is an additive manufacturing system comprising: a print head comprising: a body defining an internal flow path; a print nozzle at an outlet of the flow path; an auger disposed within the flow path, the auger operable to convey a concrete mixture towards the print nozzle; a first microwave emitter operable to alter a viscosity of the concrete moisture within the flow path by directing first microwave energy towards the internal flow path; and a second microwave emitter arranged to direct second microwave energy towards the concrete mixture when it exits the print nozzle; and a control system configured to control operation of the print head, the first microwave emitter, and the second microwave emitter.

Embodiment 16 is an additive manufacturing method comprising: conveying a concrete mixture through an internal flow path of an additive manufacturing print head; adjusting a viscosity of the concrete mixture within the internal flow path of the additive manufacturing print head by irradiating the concrete mixture with first microwave energy from a first microwave emitter while the concrete mixture is conveyed through the flow path towards a print nozzle; dispense the concrete mixture through the print nozzle; and partially curing the concrete mixture by irradiating the concrete mixture with second microwave energy from a second microwave emitter as the concrete mixture exits the print nozzle.

Embodiment 17 is the method of embodiment 16, wherein adjusting a viscosity of the concrete mixture within the internal flow path comprises controlling the first microwave emitter to adjust one or more characteristics of the first microwave energy.

Embodiment 18 is the method of embodiment 17, wherein controlling the first microwave emitter comprises: receiving sensor measurements of characteristics of the concrete mixture in the internal flow path; and controlling the first microwave emitter to adjust one or more characteristics of the first microwave energy based on the characteristics of the concrete mixture in the internal flow path.

Embodiment 19 is the method of any one of embodiments 16-18, wherein partially curing the concrete mixture comprises controlling the second microwave emitter to adjust one or more characteristics of the second microwave energy.

Embodiment 20 is the method of any one of embodiments 16-19, wherein the concrete mixture comprises additives that are receptive to microwave energy.

1. An additive manufacturing print head comprising:
a body defining an internal flow path;
a print nozzle at an outlet of the internal flow path;
an auger disposed within the internal flow path, the auger operable to convey a concrete mixture towards the print nozzle;
a first microwave emitter operable to alter a viscosity of the concrete moisture mixture within the flow path by directing first microwave energy towards the internal flow path; and
a second microwave emitter arranged to direct second microwave energy towards the concrete mixture when it exits the print nozzle.

2. The additive manufacturing print head of claim 1, wherein the first microwave emitter comprises a magnetron operatively coupled to a waveguide horn.

3. The additive manufacturing print head of claim 2, wherein an output of the waveguide horn is directed towards the internal flow path.

4. The additive manufacturing print head of claim 1, wherein the second microwave emitter comprises a magnetron operatively coupled to a waveguide horn.

5. The additive manufacturing print head of claim 4, wherein the output of the waveguide horn is directed towards an outlet of the print nozzle.

6. The additive manufacturing print head of claim 1, wherein the first microwave emitter is one of a first set of microwave emitters, each microwave emitter in the first set of microwave emitters arranged to direct microwave energy towards a region of the internal flow path.

7. The additive manufacturing print head of claim 1, wherein the second microwave emitter is one of a second set of microwave emitters, each microwave emitter in the second set of microwave emitters arranged to direct microwave energy towards the concrete mixture when it exits the print nozzle.

8. The additive manufacturing print head of claim 1, wherein the concrete mixture comprises additives that are receptive to microwave energy.

9. The additive manufacturing print head of claim 1, further comprising a control system operatively coupled to the first microwave emitter and the second microwave emitter, the control system configured to control operation of the first microwave emitter to adjust a viscosity of concrete mixture within the internal flow path.

10. The additive manufacturing print head of claim 9, wherein controlling operation of the first microwave emitter comprises controlling the first microwave emitter to adjust one or more characteristics of the first microwave energy.

11. The additive manufacturing print head of claim 10, wherein the one or more characteristics comprise power or frequency of the first microwave energy.

12. The additive manufacturing print head of claim 9, wherein controlling operations of the first microwave emitter comprises:
receiving sensor measurements of characteristics of the concrete mixture in the internal flow path; and
controlling the first microwave emitter to adjust one or more characteristics of the first microwave energy based on the characteristics of the concrete mixture in the internal flow path.

13. The additive manufacturing print head of claim 9, wherein the control system is configured to control operation of the second microwave emitter to partially cure the concrete mixture as it exits the print nozzle.

14. The additive manufacturing print head of claim 13, wherein the controlling operation of the second microwave emitter comprises controlling the second microwave emitter to adjust one or more characteristics of the second microwave energy.

15. An additive manufacturing system comprising:
a print head comprising:
a body defining an internal flow path;
a print nozzle at an outlet of the flow path;
an auger disposed within the flow path, the auger operable to convey a concrete mixture towards the print nozzle;
a first microwave emitter operable to alter a viscosity of the concrete mixture within the flow path by directing first microwave energy towards the internal flow path; and
a second microwave emitter arranged to direct second microwave energy towards the concrete mixture when it exits the print nozzle; and
a control system configured to control operation of the print head, the first microwave emitter, and the second microwave emitter.

16. The system of claim 15, wherein the control system is configured to control performance of operations comprising:
causing the print head to convey the concrete mixture through the internal flow path of the print head;
adjusting a viscosity of the concrete mixture within the internal flow path of the additive manufacturing print head by controlling the first microwave emitter to irradiate the concrete mixture with first microwave energy while the concrete mixture is conveyed through the internal flow path towards the print nozzle;
causing the print head to dispense the concrete mixture through the print nozzle; and
partially curing the concrete mixture by controlling the second microwave emitter to irradiate the concrete mixture with second microwave energy as the concrete mixture exits the print nozzle.

17. The system of claim 16, wherein adjusting a viscosity of the concrete mixture within the internal flow path comprises controlling the first microwave emitter to adjust one or more characteristics of the first microwave energy.

18. The system of claim 17, wherein controlling the first microwave emitter comprises:
receiving sensor measurements of characteristics of the concrete mixture in the internal flow path; and
controlling the first microwave emitter to adjust one or more characteristics of the first microwave energy based on the characteristics of the concrete mixture in the internal flow path.

19. The system of claim 16, wherein partially curing the concrete mixture comprises controlling the second microwave emitter to adjust one or more characteristics of the second microwave energy.

20. The system of claim 16, wherein the concrete mixture comprises additives that are receptive to microwave energy.
